(19) United States
(12) Patent Application Publication
(10) Pub. No.: US 2005/0150614 A1
(43) Pub. Date: Jul. 14, 2005

(54) Slat set for window blind

(75) Inventors: Ming Nien, Changhua Hsien (TW); David Kuei-Tin Pon, Irvine, CA (US)

Correspondence Address: BACON & THOMAS, PLLC, 625 SLATERS LANE, FOURTH FLOOR, ALEXANDRIA, VA, 22314, US

(73) Assignee: NIEN MADE ENTERPRISE CO., LTD., TAICHUNG (TW)

(21) Appl. No.: 10/832,368

(22) Filed: Apr. 27, 2004

(30) Foreign Application Priority Data
Jan. 14, 2004 (TW) 93200686

(51) Int. Cl. E06B 3/12

(52) U.S. Cl. 160/236

(57) ABSTRACT

A slat set for a window blind includes a plurality of serially alternatively arranged odd-numbered slats and even-numbered slats. The odd-numbered slats each have a cross section having a midpoint, a recessed portion at a left side of the midpoint, and a raised portion at a right side of the midpoint. The even-numbered slats each have a cross section having a midpoint, a raised portion at a left side of the midpoint, and a recessed portion at a right side of the mid point.

### BACKGROUND OF THE INVENTION

1. Field of the Invention

The present invention relates to a window blind and more specifically, to a slat set for a window blind, which achieves the best shielding effect.

2. Description of the Related Art

A window blind is generally comprised of a headrail and a slat set formed of a number of slats. Regular window blinds include vertical window blinds and horizontal window blinds. A vertical window blind has the slats arranged in vertical. A horizontal window blind has the slats arranged in horizontal. These two types of window blinds commonly use a tilting mechanism to control tilting angle of the slats. When closed the slat set, the slats are biased to the maximum angle, achieving the best shielding effect. However, the slats may not be able to move to the fully closed position due to curving of slat body caused by gravity, improper installation or design of the tilting mechanism, or loosening or damage of other parts from a long use.

The slats of regular window blinds commonly have a rectangular cross section. When the slat set formed of slats having a rectangular cross section is closed, i.e. the slats biased to tilting angle θ as shown in FIG. 1, incident light may pass through the gap P between each two adjacent slats. Through the gap P, people can see the inside from the outside of the room. In order to eliminate this problem, there are manufacturers who provide window blinds using slats having an S-shaped cross section as shown in FIG. 2. This design relatively narrows the gap between each two adjacent slats. However, when the slats biased to the maximum tilting angle θ, there is still a gap P1 left between each two adjacent slats.

Therefore, it is desirable to provide a slat set for a window blind that eliminates the aforesaid problem.

### SUMMARY OF THE INVENTION

It is the primary objective of the present invention to provide a slat set for a window blind, which minimizes the gap between each two adjacent slats after closing of the blind, achieving the best shielding effect.

To achieve this objective of the present invention, the slat set comprises a plurality of slats for being serially arranged below a head rail of a window blind vertically or horizontally. The odd-numbered slats of the serial slats each have a cross section having a midpoint, a recessed portion at a left side of the midpoint, and a raised portion at a right side of the midpoint. The even-numbered slats of the serial slats each have a cross section having a midpoint, a raised portion at a left side of the midpoint, and a recessed portion at a right side of the mid point.

### BRIEF DESCRIPTION OF THE DRAWINGS

FIG. 1 is a schematic drawing of a slat set for a window blind according to the prior art, showing the slats biased to the close status.

FIG. 2 is a schematic drawing of another prior design of a slat set for a window blind assembly, showing the slats not in a fully closed status.

FIG. 3 is a perspective view of a preferred embodiment of the present invention showing the open status of the slats.

FIG. 4 is a side view of FIG. 3.

FIG. 5 is another perspective view of the preferred embodiment of the present invention, showing the closed status of the slats.

FIG. 6 is a side view of FIG. 5.

FIG. 7 is a side view of the preferred embodiment of the present invention showing the slats not fully closed.

### DETAILED DESCRIPTION OF THE INVENTION

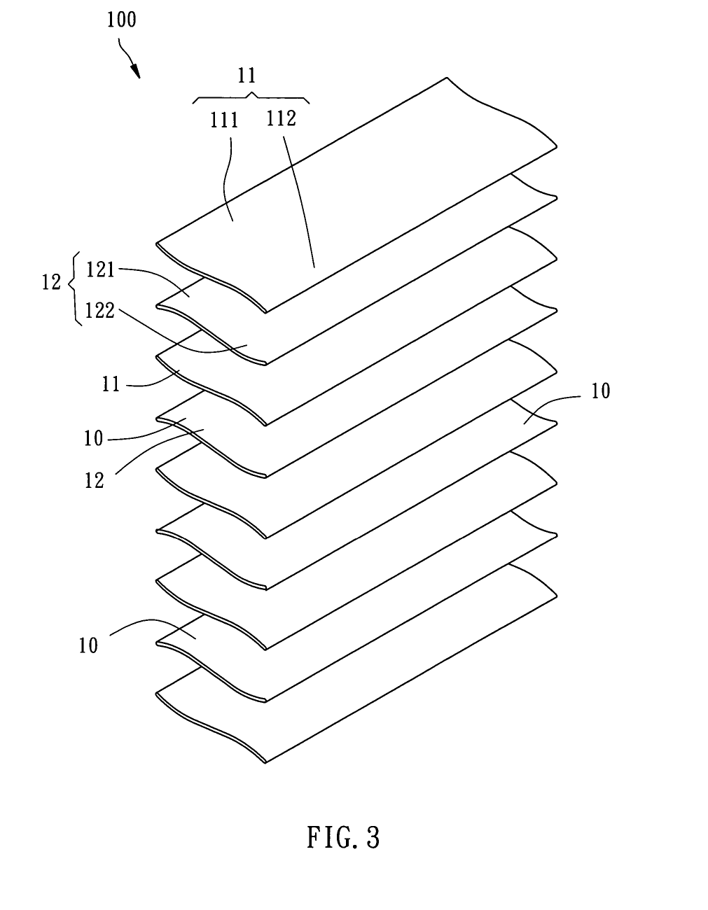

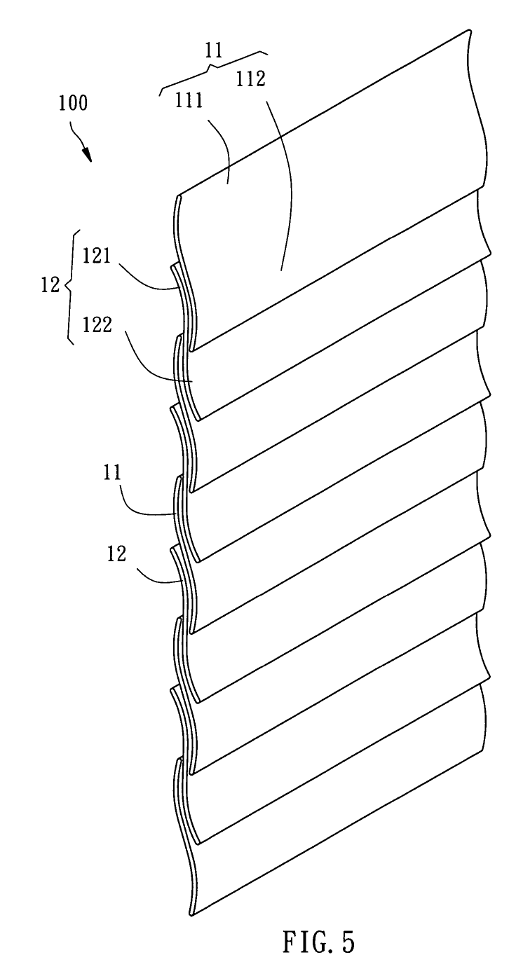

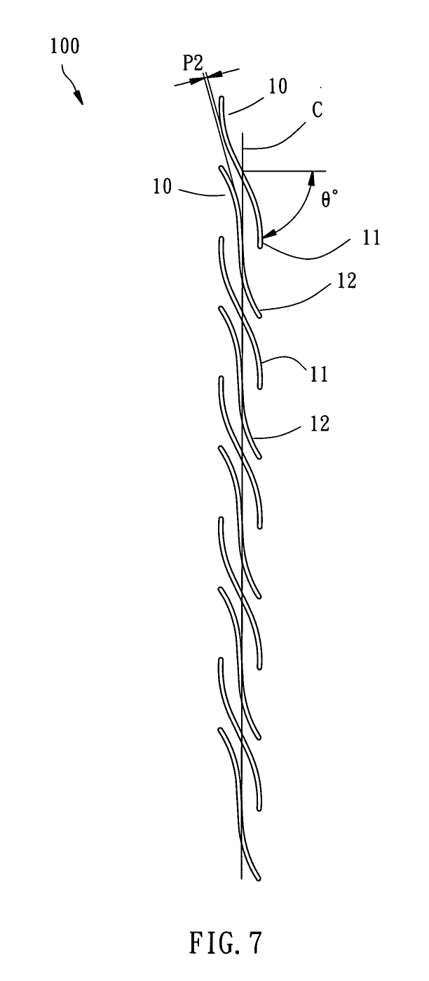

Referring to FIGS. 3-7, a slat set 100 for a window blind is shown comprised of a plurality of serially arranged slats 10. It is to be understood that the slats are parallel spacedly suspended below the headrail of a window blind (not shown in the drawings) in a vertical position to form a vertical window blind, or a horizontal position to form a horizontal window blind.

The slats 10 can be made of plastics, wood, metal, or any of a variety of other compound materials. The odd-numbered slats 11, i.e. the first slat, the third slat and etc., have a substantially S-shaped cross section, i.e., the midpoint C of the width of the cross section of each odd-numbered slat 11 divides the cross section into a recessed portion 111 at the left side and a raised portion 112 at the right side. The recessed portion 111 curves inwards subject to the angle of a predetermined arc line, forming an inwardly curved cambered surface. The raised portion 112 is integrally joined to the recessed portion 111, and curved outwards subject to a predetermined arc line equal to the arc line of the recessed portion 111; therefore the raised portion 112 has a shape in an inverted mirror status relative to the recessed portion 111. The even-numbered slats 12, i.e. the second slat, the fourth slat and etc., have a substantially reversed S-shaped cross section, i.e., the midpoint C of the width of the cross section of each even-numbered slat 12 divides the cross section into a raised portion 121 at the left side and a recessed portion 122 at the right side. The raised portion 121 of each even-numbered slat 12 curves in the same angle of arc line as the raised portion 112 of each odd-numbered slat 11, forming an outwardly curved cambered surface. The recessed portion 122 is integrally joined to the raised portion 121, and curved inwards at an angle equal to the arc line of the recessed portion 111; therefore the raised portion 122 and recessed portion 121 of each even-numbered slat 12 are in an inverted mirror status.

Actually, the main point of the design of the present invention is characterized in that the shape of the left side of each odd-numbered slat 11 and the shape of the right side of each even-numbered slat 12 are in a complementary status and not a linear line; further the shape of the right side of each odd-numbered slat 11 and the shape of the left side of each even-numbered slat 12 are in a complementary status and not a linear line. This design achieves the best shielding effect.

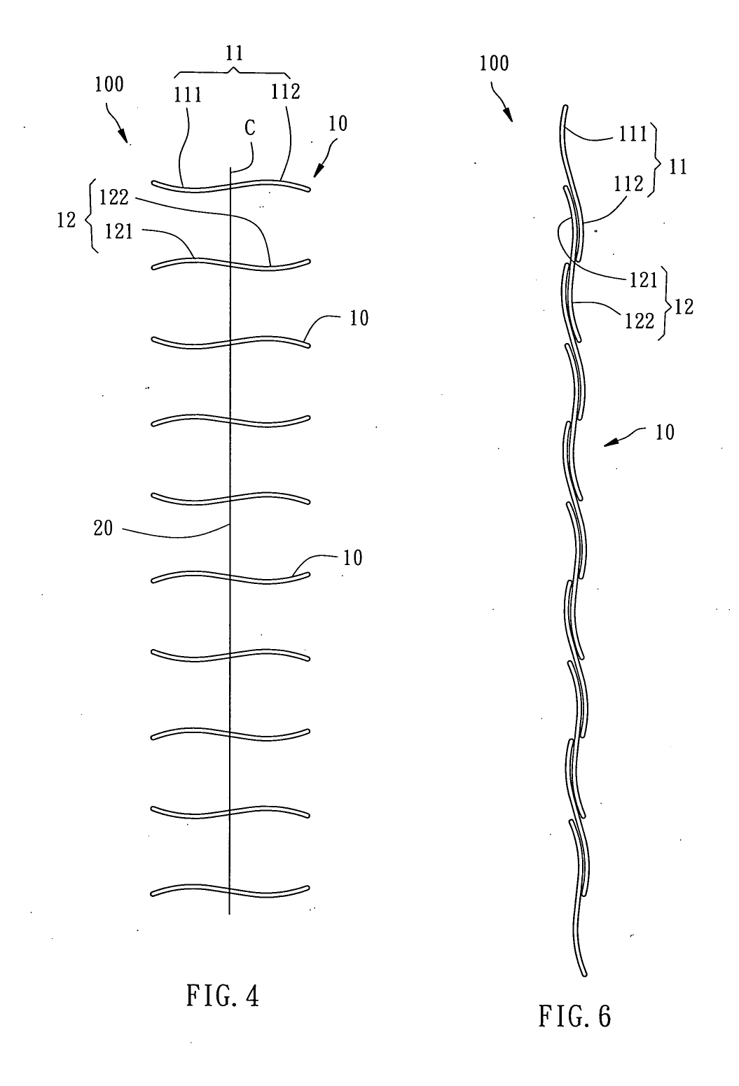

The installation and use of the slat set are described hereinafter. If the user wishes to close the slat set 100 (to shield incident light) after the slats 10 have been properly arranged in position as shown in FIG. 4, the user can then operate the tilting mechanism (not shown) to bias the slats 10 from horizontal status (see FIG. 4) to vertical status (see FIG. 6). At this time, the slats 10 are turned toward the first direction (clockwise direction) to the close status where the upper part of the raised portion 121 of each even-numbered slat 12 is respectively closely attached to the lower part of the raised portion 112 of each odd-numbered slat 11. Because the raised portions 112 of the odd-numbered slats 11 and the raised portions 121 of the even-numbered slats 12 have the same arc line, they can smoothly be attached to one another. When closed the slat set 100, the slats 10 show a tender arch line of corrugations, causing a sense of beauty.

If the slats 10 must be biased in a second direction (counter-clockwise direction) due to a different installation method when closing the slat set 100, the recessed portions 111 of the odd-numbered slats 11 will be respectively smoothly attached to the recessed portions 122 of the even-numbered slats 12, achieving same effect.

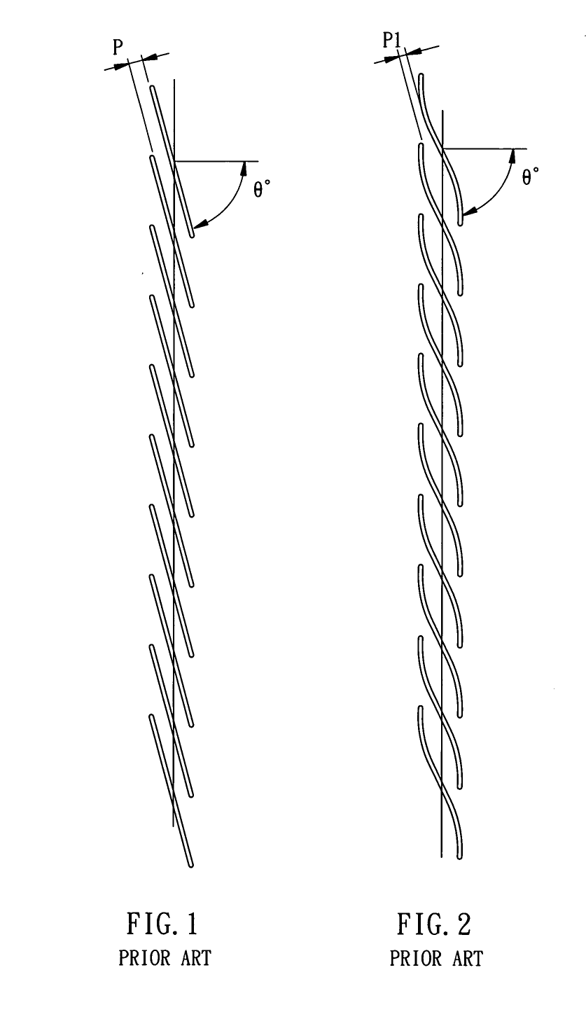

If the slats 10 cannot be biased to vertical status and smoothly and closely attached to one another after closing of the slat set 100 due to loosening or damage of parts of the window blind, the mirror gap P2 between each two adjacent slats 11 and 12 is insufficient to let outside incident light pass. Because the opposing sides of each two adjacent slats 11 and 12 are in a complementary status and do not have the profile of a straight line, the gap P2 between each two adjacent slats 11 and 12 is relatively smaller (in comparison to the same tilting angle θ of the slats shown in FIGS. 1 and 2), achieving a relatively better shielding effect.

Although particular embodiments of the invention have been described in detail for purposes of illustration, various modifications and enhancements may be made without departing from the spirit and scope of the invention. Accordingly, the invention is not to be limited except as by the appended claims.

1. A slat set for a window blind, comprising a plurality of slats including odd-numbered slats and even-numbered slats arranged alternatively and serially;
wherein said odd-numbered slats each have a cross section having a midpoint, a recessed portion at a left side of the midpoint, and a raised portion at a right side of the midpoint;
wherein said even-numbered slats each have a cross section having a midpoint, a raised portion at a left side of the midpoint, and a recessed portion at a right side of the mid point.

2. The slat set as defined in claim 1, wherein the recessed portion of each said odd-numbered slat curves inwards subject to the angle of a predetermined arc line, forming an inwardly curved cambered surface and the raised portion of each said odd-numbered slat is joined to the recessed portion of the respective odd-numbered slat and curved outwards at an angle equal to the angle of the arc line of the recessed portion of each said odd-numbered slat such that the raised portion of each said odd-numbered slat has a shape in an inverted mirror status relative to the recessed portion of each said odd-numbered slat; the raised portion of each said even-numbered slat curves in the same angle of arc line as the raised portion of each said odd-numbered slat, forming an outwardly curved cambered surface, and the recessed portion of each said even-numbered slat is joined to the raised portion of the respective even-numbered slat and curved inwards at an angle equal to the arc line of the recessed portion of each said odd-numbered slat such that the raised portion and recessed portion of each said even-numbered slat are in an inverted mirror status.

3. The slat set as defined in claim 1, wherein the raised portions of said odd-numbered slats and the raised portions of said even-numbered slats have the same shape; the recessed portions of said odd-numbered slats and the recessed portions of said even-numbered slats have the same shape.

4. The slat set as claimed in claim 1, wherein the raised portions of said even-numbered slats and the raised portions of said odd-numbered slats are respectively curved outwards subject to a same arch line; the recessed portions of said even-numbered slats and the recessed portions of said odd-numbered slats are respectively curved inwards subject to a same arch line.

5. A slat set for a window blind, comprising a plurality of slats including odd-numbered slats and even-numbered slats arranged alternatively and serially;
wherein said odd-numbered slats each have a substantially S-shaped cross section and said even-numbered slats each have a substantially inversed S-shaped cross section.

6. A slat set for a window blind, comprising a plurality of slats including odd-numbered slats and even-numbered slats arranged alternatively and serially, said odd-numbered slats and said even-numbered slats each having a cross section;
wherein the cross section of each said odd-numbered slat has a left part nonlinearly complementary with a right part of the cross section of each said even-numbered slat, and a right part nonlinearly complementary with a left part of the cross section of each said even-numbered slat.

7. The slat set as claimed in claim 6, wherein the left part of each said odd-numbered slat and the right part of each said even-numbered slat are respectively curved inwards; the right part of each said odd-numbered slat and the right part of each said even-numbered slat are respectively curved outwards.

8. A window blind comprising:
a headrail; and
a slat set including a plurality of slats having odd-numbered slats and even-numbered slats serially alternatively suspended below said headrail;
wherein each said odd-numbered slat has a left part nonlinearly complementary in cross section with a right part of each said even-numbered slat, and a right part nonlinearly complementary in cross section with a left part of each said even-numbered slat.

9. The window blind as claimed in claim 8, wherein the left part of each said odd-numbered slat and the right part of each said even-numbered slat are respectively curved inwards; the right part of each said odd-numbered slat and the right part of each said even-numbered slat are respectively curved outwards.

10. The window blind as claimed in claim 8, wherein said slats are set in vertical below said headrail.

11. The window blind as claimed in claim 8, wherein said slats are set in horizontal below said headrail.
